(19) United States
(12) Patent Application Publication
(10) Pub. No.: US 2026/0170069 A1
(43) Pub. Date: Jun. 18, 2026

(54) INTENT INTELLIGENCE LAYER FOR NETWORK COMPONENTS

(71) Applicant: Verizon Patent and Licensing Inc., Basking Ridge, NJ (US)

(72) Inventors: Hitesh K Patel, San Diego, CA (US); Ramraj Bishnoie, Sunnyvale, CA (US); Gaurav Goel, Los Gatos, CA (US); Rakshit Trivedi, Parsippany, NJ (US); Scott R Tanner, Sharpsburg, GA (US)

(21) Appl. No.: 18/981,755

(22) Filed: Dec. 16, 2024

(51) Int. Cl. G06F 16/9535; G06F 9/54

(52) U.S. Cl. CPC G06F 16/9535; G06F 9/542; G06F 9/547

(57) ABSTRACT

One or more computing devices, systems, and/or methods for an intent intelligence layer for a network component are provided. The intent intelligence layer includes an intent classifier that generates similarity scores between a user prompt received by the network component and categories corresponding to services accessible to the network component. An intent of the user prompt is determined based upon contextual information of a user. An artificial intelligence (AI) planner model generates a task based upon the intent and a category. An AI agent is invoked to perform the task using a service corresponding to the category. A response is generated and provided to the user based upon a result of the task being performed.

### BACKGROUND

Many services leverage artificial intelligence for creating personalized experiences through chatbots, digital assistants, and custom interfaces. For example, a user may access a website of a business. The website may host a chatbot through a chatbot interface. The user may submit product questions and other questions through the chatbot interface. Various machine learning models may be used to generate answers that are provided back to the user through the chatbot interface.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for implementing an intent intelligence layer for a network component, in accordance with an embodiment of the present technology;

FIG. 2 illustrates an example of a method for implementing an intent intelligence layer for a network component, in accordance with an embodiment of the present technology;

FIG. 3 illustrates an example of a system for implementing an intent intelligence layer for a network component, in accordance with an embodiment of the present technology;

FIG. 4 illustrates an example of a flow chart for implementing an intent intelligence layer that executes an intended action, in accordance with an embodiment of the present technology;

FIG. 5A-5E illustrate examples of a system for implementing an intent intelligence layer for a network component, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

Systems and methods are provided for an intent intelligence layer for network components. Network components, such as a router, provide devices with wired and wireless communication capabilities. The devices may connect to the router through Ethernet cables, over a WiFi connection, etc. The router may be connected to a modem that provides the devices, connected to the router, with access to the Internet. Conventional routers provide basic communication, connectivity, and troubleshooting functionality that may require multiple manual steps. Thus, the functionality provided by network components is limited, and the functionality often includes time consuming manual effort such as to onboard or troubleshoot a device.

The disclosed intent intelligence layer improves the operation and functionality of network components by integrating new artificial intelligence (AI) functionality into network components that may otherwise lack such functionality. In some embodiments, the intent intelligence layer may be directly hosting within a network component, such as where a central processing unit (CPU) or graphics processing unit (GPU) of a router hosts and executes the intent intelligence layer. In some embodiments, the intent intelligence layer may be hosted on a device separate from a network component such that the device may be coupled to the network component in order to provide the network component with the AI functionality not natively provided by the network component.

The intent intelligence layer hosts an intent classifier and an AI planner model that implement AI functionality for processing user prompts received by a network component. For example, the user may speak a user prompt “can you create a restaurant menu to display on the television at my restaurant.” The intent intelligence layer may have access to various services that can be invoked to perform actions related to an intent of the user prompt. The services may be capable of obtaining business information (e.g., obtaining transaction data, inventory data, employee data, business contact and sales data, etc.), sending messages and alerts, monitoring devices or data sources for events (e.g., a fire alarm triggering), performing routing tasks, evaluating imagery or video using computer vision, etc. The intent classifier compares the user prompt to categories corresponding to the services in order to determine similarity scores between the user prompt and the categories. The intent classifier determines an intent of the user prompt based upon contextual information, such as information related to a business of the user (e.g., information within a customer relationship management database, a business description, information extracted from a website of the business, files or database tables storing business information, a business profile created while onboarding the business with a service, etc.).

The AI planner model utilizes the intent of the user prompt and one or more categories having highest similarity (correspondence or relevance) to the user prompt to generate a plan of tasks to perform in order to carry out the intent of the user prompt. The AI planner model identifies or dynamically constructs AI agents that can create and send application programming interface (API) calls to the services for generating task results. For example, the plan to may be to obtain a video feed from a camera connected to the network equipment, utilize computer vision to determine whether the video feed depicts a person within a store after hours, and send an email notification of a detected intruder. The task results are used to generate a response that is provided back to the user, such as a response that email notifications will be sent if any intruders are detected. In this way, the intent intelligence layer provides the network component, such as a router, with the ability to automate tasks utilizing AI and various services. The intent intelligence layer provides personalized dynamic alerts, utilizes generative AI to generate business content, provides a user with actionable insight for operating and growing a business, and automates routine and complex tasks in order to same time, money, and effort.

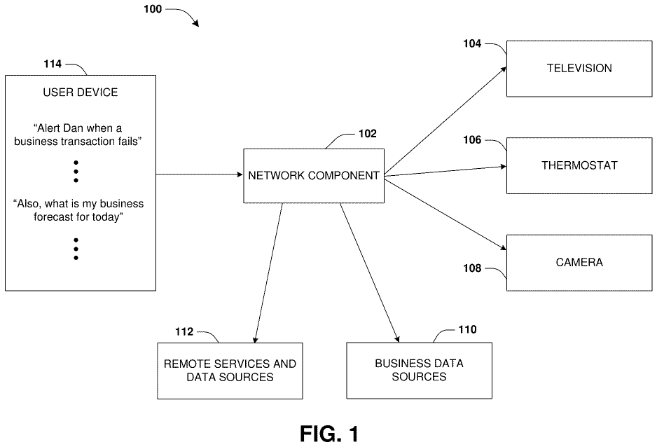

FIG. 1 illustrates an example of a system 100 for implementing an intent intelligence layer (an AI layer) for a network component. The system 100 includes a network component 102 such as a device that facilitates communication over a network (e.g., a router). The network component 102 may be connected to various devices, such as a television 104, a thermostat 106, a camera 108, and/or other devices such as printers, speakers, Internet of Things (IoT) devices, etc. The network component 102 may have network connectivity to access business data sources 110 (e.g., business transaction data, a business website, a business profile, a business description, information from a user while onboarding a business with a service, customer relationship management data, etc.). The network component 102 may have network connectivity to access remote services and data sources 112. In this way, the network component 102 has access to devices, services, and data sources that can be used for performing actions that satisfy an intent of a user prompt received by the network component 102.

The network component 102 may implement an intent intelligence layer that is either incorporated into the network component 102 or is hosted within a device connected to the network component 102. The intent intelligence layer is capable of performing various actions in response to user prompts. In some embodiments, the intent intelligence layer is implemented as an AI assistant, chatbot, a user interface displayed on a user device, a voice activated assistant that listens through a device or through the network component 102 for user prompts. In this way, the intent intelligence layer can receive and process user prompts in order to perform actions related to an intent of a user prompt.

A user device 114 may connect to the network component 102, such as where a mobile phone connects to the router through a WiFi connection. The user may input a user prompt through the user device 114 using a virtual keyboard, a voice command, a touch command, etc. For example, the user may input a user prompt “Alert Dan when a business transaction fails” through a user interface of the user device 114. In another example, the user may input a user prompt “Also, what is my business forecast for today.” An application hosting the user interface may send the user prompt to the network component 102 (e.g., the mobile phone may send the user prompt over the WiFi connection to the router).

The intent intelligence layer determines an intent of the user prompt such as where the user wants a text message to be sent to a mobile device number of Dan within a business contact list of the user when a business purchase transaction fails for a business associated with the user. The intent intelligence layer may identify one or more categories that are similar to the user prompt. Each category may relate to a service accessible to the network component 102 that can be invoked to perform actions related to the intent of the user prompt. The intent intelligence layer may create vector representations of the categories and user prompt, and may utilize a similarity function to assign similarity scores to the categories. A similar score represents how similar (related/relevant) a category is to the user prompt. For example, a category of a service that monitors a fire alarm may be assigned a relatively lower similarity score than a category of a service that accesses business transaction data within the business data sources 110.

The intent intelligence layer may generate a plan to perform tasks derived from the intent of the user prompt and the one or more categories. The tasks of the plan are executed to invoke corresponding services to perform actions related to the plan. For example, a point of sale (POS) service may be invoked to monitor the business data sources 110 for failed transactions, and a messaging service may be used to send text messages to the mobile device number of Dan if a business purchase transaction fails. A response is provided back to the user through the user device, such as to indicate that a text message will be sent to Dan if a business transaction fails. Depending on the intent of the user prompt and the category, various types of tasks may be performed by different services that may access calendar data, email, the television, the thermostat, the camera, remote data sources, and/or other devices, services, and data sources in order to implement the plan created by the intent intelligence layer.

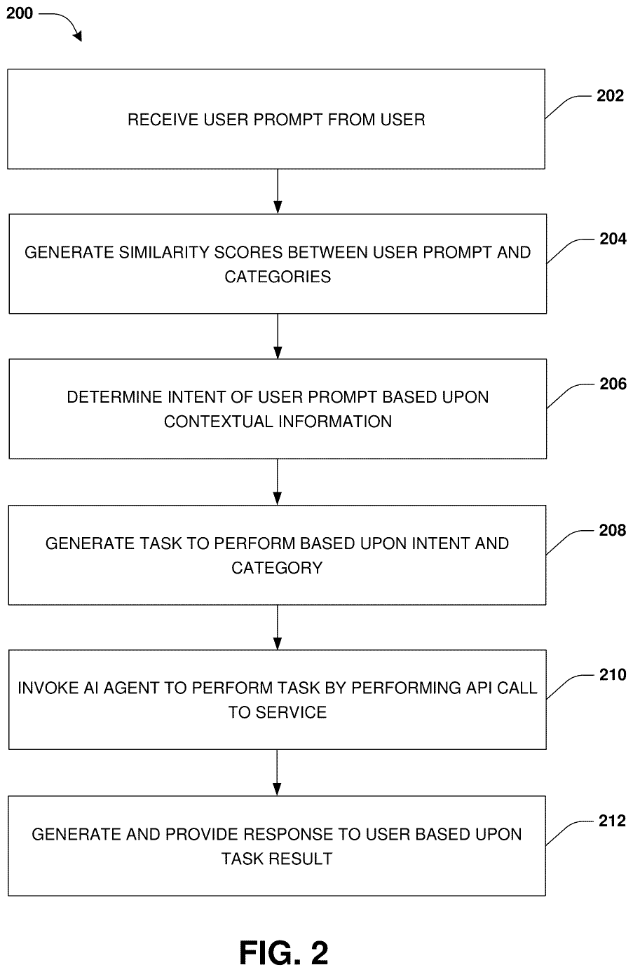

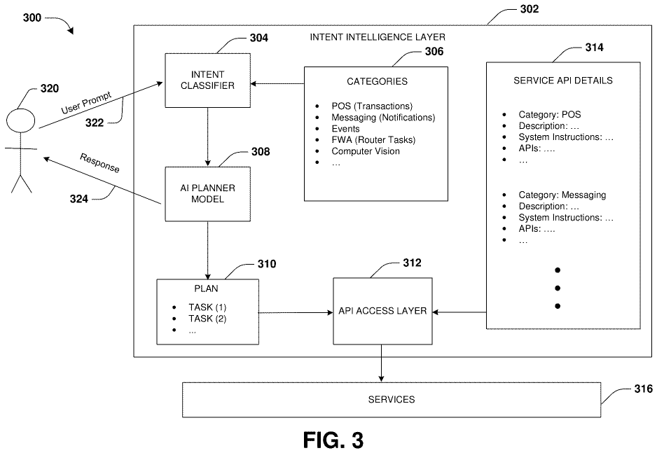

FIG. 2 illustrates an example of a method 200 for implementing an intent intelligence layer 302 (an AI layer) for a network component, which is described in conjunction with system 300 of FIG. 3. The network component may comprise a router or any other equipment capable of connecting to services and/or devices, such as a television, a smart speaker, a sensor, a camera, a phone, laptop, or any other device. The network component may provide connectivity and/or routing functionality for devices that are connected to the network component through wired connections and/or wireless connections.

In some embodiments, the intent intelligence layer 302 may be integrated into the network component, such as where a CPU or GPU of the network component executes the intent intelligence layer 302. The network component may host one or more machine learning models (e.g., large language models, a vision language model, a sentence transformer model, an alert engine, etc.) on device within the network component. In some embodiments, the intent intelligence layer 302 is hosted by a device connected to the network component, such as where a universal serial bus (USB) dongle or other device is connected into a USB port of a router in order to provide the router with additional functionality, through the intent intelligence layer 302, not natively supported or provided by the router.

Service API details 314 may be defined for use by the intent intelligence layer 302. The service API details 314 may define various services that are accessible to the intent intelligence layer 302 for processing user prompts. The service API details 314 may define a messaging service used to transmit messages such as emails and text messages to users. The service API details 314 may define a point of sales service used to retrieve transactions related to a business associated with the user (e.g., the user may operate a small business, such as a yoga studio, a pizza shop, an appliance repair shop, etc.). The transactions may relate to customers purchasing products and services from the business. The transaction may relate to any type of transaction such as the business purchasing equipment or inventory. The service API details 314 may define an event monitoring service used to monitor data sources (e.g., monitor data provided by a service, such as a weather service), a sensor (e.g., a fire alarm), or any other service or device for occurrence of events (e.g., a fire alarm going off, snowy weather, available inventory of an item falling below a threshold, a camera detecting a customer waiting at a service desk for longer than 1 minute without being helped, or any other type of event). If an event occurs, then the messaging service may be used to send a message alert of the event occurring. The service API details 314 may define a computer vision service used to execute computer vision functionality upon imagery or video (e.g., evaluate a video feed from a camera to detect whether a customer has been waiting at a service desk for longer than 1 minute without being helped).

The service API details 314 may associate a category with a service. The service API details 314 may provide a description for the service. The service API details 314 may provide system instructions for the service (e.g., a prompt to input into a machine learning model for controlling how the machine learning model will operate). The service API details 314 may provide a list of APIs (API endpoints) hosted by the service that can be called by the intent intelligence layer 302. The list of APIs may specify types of API calls such as PUT, GET, etc. and parameters required by the API calls. In some embodiments, the service API details 314 include a router category. The router category has a description such as “access to multiple router features and functionality via REST APIs, list devices, block specific device, monitor network bandwidth, monitor device throughput, allocate higher QoS to a device” that relate to functions that a router service can perform. The router category has a system instruction such as “You are a helpful AI agent who responds precisely and ACCURATELY for all router related features. You ONLY ask for more information when you have not understood the intention in the query. You DO NO RESPOND WITH GARBAGE NUMBERS or partial data without providing the full context. You ALWAYS RESPOND with a brief summary in NO MORE THAN 2 LINES. You can invoke different Router features and functions. You help {USER} to troubleshoot network connectivity, setup Guest Wi-Fi network, Block Devices, Get Bandwidth information, Device Information ‘Device Type like phone, laptop, tablet, smart device, smart switches, cameras,’ only when you do not understand the question accurately you ask for more information.” The system instruction may be input as a prompt into a model used by the network component for processing user prompts and/or executing tasks of a plan implemented to satisfy a user intent of the user prompts (e.g., an LLM, a generative model, a model used to power an AI agent or chatbot, etc.).

The router category has a list of APIs, such as a first API function to “factory reset, power cycle or reset while preserving the password of router. One of the provided actions is performed on router with this API.” The first API function specifies an HTTP method of “PUT.” The first API function specifies an API endpoint with an IP address, port, and other information. The first API function specifies API parameters expected by the API endpoint of the router service such as “action: power cycle, factory_reset, reset_preserve_PWD.” In this way, the information within the service API details 314 may be used to make various types of API calls to the router service for processing a user prompt. Each service may be mapped to a category. The categories 306, such as a point of sale category, a messaging category, an events category, a fixed wireless access category, a computer vision category, and/or other categories may be provided to an intent classifier 304 for understanding the intent of user prompts.

It may be appreciated that the service API details 314 may be dynamically updated to add, remove, or modify descriptions of services, and that any type of service may be added to the service API details 314 (e.g., a service that implements machine learning and/or artificial intelligence to perform tasks or analyze data). In some embodiments, the service API details 314 are stored as a file on the network component (e.g., a file stored within storage or memory of a router), and thus an update may be transmitted by a service provider over a network to the network component to modify or replace the file with updated service API details.

One or more services may be internal on-device services hosted by the network component, such as a fixed wireless access service used by the network component to execute router tasks. One or more services may be remote and external to the network component, such as a customer relationship management platform used to store business data of the business (e.g., customer contact information, transaction data, employee data, business deals data, customer service ticket data, and/or other data that may be stored within a database hosted external to the network component).

In some embodiments, a user 320 may connect a user device to the network component. The user 320 may input a user prompt into the user device. The user device transmits the user prompt 322 to the intent intelligence layer 302 of the network component. In some embodiments, the user 320 may directly input, such as speak, the user prompt 322 into the network component that may receive the user prompt 322 through a microphone of the network component (e.g., a microphone integrated into a router). In some embodiments where the intent intelligence layer 302 is hosted on a device connected to the network component, the device may receive the user prompt through a microphone of the device. Accordingly, during operation 202 of method 200, the user prompt 322 is received from the user 320 by the network component.

During operation 204 of method 200, an intent classifier 304 of the intent intelligence layer 302 generates similarity scores between the user prompt 322 and the categories 306 corresponding to the services accessible to the network component. In some embodiments, the intent classifier 304 generates a prompt vector to represent the user prompt 322 in vector space (e.g., different dimensions corresponding to various features of the user prompt 322). The intent classifier 304 generates category vectors to represent each of the categories 306. The intent classifier 304 compares the prompt vector and the category vectors to generate similarity scores (e.g., how similar are the features represented by the dimensions of the vectors). In some embodiments, the intent classifier 304 utilized a sentence transform function as part of assigning the similarity scores (vector similarity scores). One or more categories having the highest similarity scores may be selected, such as where a category is selected if the category has a similarity score exceeding a threshold.

During operation 206 of method 200, an intent of the user prompt may be identified based upon contextual information of the user 320. The contextual information may relate to business information of a business of the user. The intent intelligence layer 302 may have access to a service with which the business has been registered or on boarded, and thus the intent intelligence layer 302 can utilize the service to access the business information, such as a business location, type of business, customer contacts, inventory, business operating hours, employee information, devices located at the business such as a camera or fire alarm, etc. The user prompt may relate to an aspect of the business, such as “what is my business forecast for today,” which may relate to a sales forecast and other information of the business. In this way, the intent of the user prompt may be identified.

During operation 208 of method 200, an AI planner model 308 of the intent intelligence layer 302 may generate a plan 310 that includes one or more tasks to perform based upon the intent and the one or more selected categories. In some embodiments, the intent classifier 304 inputs the one or more selected categories and the user prompt into the AI planner model 308 for creating the plan 310. A task of the plan 310 may be a smallest possible task in natural language (NL). In some embodiments, an AI agent may be dynamically generated for each task of the plan 310 as a task specific AI agent assigned to perform a particular task. In some embodiments, an AI agent is implemented as a service or other executable code (e.g., code executed through a container, a virtual machine, a serverless thread, an application, etc.) that may utilize a machine learning model or other artificial intelligence functionality to perform a task (e.g., a service that executes code to generate an API call to an endpoint for retrieving information from the endpoint). In some embodiments, the type of task to perform may be used to select, generate, or customize the service or executable code as the AI agent (e.g., prompting to tailor the AI agent to perform a particular task such as operate a camera to receive a video feed, or a task to query a database for business forecast information). In some embodiments, an existing AI agent may be selected for a task if there is an existing AI agent capable of executing the task, otherwise, a new AI agent is dynamically generated. In some embodiments, a dynamic AI model is generated for each task of the plan 310, and each dynamic AI model corresponds to an AI agent (a task specific AI agent).

During operation 210 of method 200, an AI agent is invoked to perform each task of the plan 310. An AI agent may utilize the service API details 314 and an API access layer 312 to generate an API call to a service of available services 316 for performing a task. Each AI agent may perform various API calls to the services 316 to generate task results for the tasks. A task result may relate to setting up an event service to monitor available inventory for detecting low inventory, configuring a notification service to send notifications of when inventor is low, etc. In some embodiments, an AI agent utilizes a service to monitor for occurrence of an event, and another service is used to send alerts to a user if the event occurs. In some embodiments, an AI agent invokes a service to control operation of a device (e.g., a television, a printer, a file server, a smart speaker, etc.) connected to the network component. Machine learning functionality, such as computer vision, may be used to process data collected from the device to generate a task result. In some embodiments, an AI agent invokes a service to automate execution of an action, such as ordering new inventory when inventory becomes low. In some embodiments, RestGPT is used to fetch task results from an API endpoint, and returns a task result for a current task of the plan 310 being executed.

In some embodiments, a task result is evaluated to determine whether the plan 310 can or cannot continue to a next task. For example, a camera may be experiencing an operational issue, and thus a task to monitor a video feed from the camera cannot be setup. Accordingly, a new plan with a new set of tasks may be generated. The new plan may include a different camera or a task to reset of the camera having the operational issue. In this way, new plans may be generated in order to make constructive progress forward in satisfying the intent of the user prompt 322. If a threshold number of plans are created, then an error may be returned to the user 320.

In some embodiments, various actions are performed as part of executing the plan 310, which may be an ongoing plan 310 where actions are performed over a time period or indefinitely, such as to monitor a store for customers entering the store, tracking low inventory, sending alerts of events occurring, etc. The actions may relate to live speech translation. The actions may relate to video surveillance using cameras connected to the network component. The actions may relate to automated scheduler manager functionality (e.g., performing actions at certain times). The actions may relate to business insight generation (e.g., generating a suggestion for how to attract more customers based upon success of prior marketing activities). The actions may relate to business suggestion generation (e.g., a suggestion to replenish inventory or change a price set point of an item). The actions may relate to periodic business analytic analysis (e.g., sales forecasting). The actions may relate to network diagnostic functionality provided by the network component. The actions may relate to device onboarding (e.g., setting up and configuring a device, such as by registering a device with a service). The actions may relate to voice enabled operation (e.g., controlling a smart speaker using voice commands).

During operation 212 of method 200, a response 324 is generated based upon the task results generated from the plan 310 being executed by the AI agents using the API access layer 312 to perform API calls to the services 316 for performing actions related to satisfying the intent of the user prompt 322. In this way, the response is provided back to the user 320, such as through a user interface of the user device.

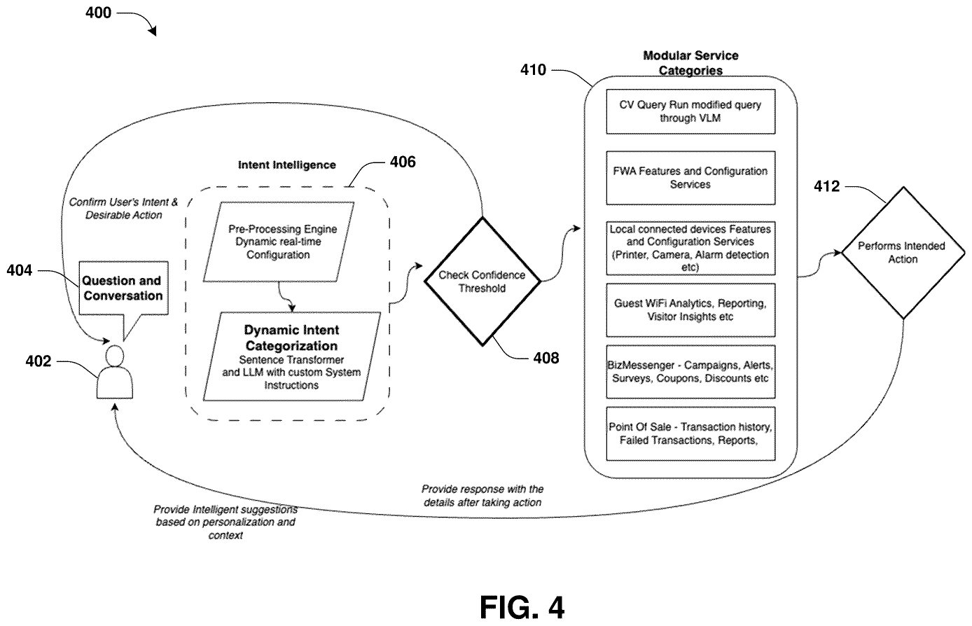

FIG. 4 illustrates an example of a flow chart 400 for implementing an intent intelligence layer that executes an intended action. A user prompt 404, such as a question asked during a conversation between a user 402 and a device hosting the intent intelligence layer, is received. The intent intelligence layer determines a user intent and desired action using intent intelligence 406. For example, a pre-processing engine utilizes a dynamic real-time configuration to execute dynamic intent categorization that determines an intent of the user prompt 404 and identifies one or more categories of services that are similar/relevant to the user prompt 404. In this way, the intent of the user prompt 404 and the one or more categories are used to generate a plan of tasks that are performed by executing actions satisfying the intent of the user prompt 404. In some embodiments an intent classifier may implement the intent intelligence 406, which may utilize a sentence transformer and LLM with custom system instructions defined by service API details.

If a confidence of the intent intelligence exceeds 408 a threshold, then one or more categories of services (modular service categories 410) may be used to perform the intended action(s) 412 to satisfy the intent of the user prompt 404. The categories may relate queries run through models, fixed wireless access (FWA) features and configuration services, locally connected device features and configuration services (e.g., printer, camera, alarm detection, etc.), guest WiFi analytics, reporting, and visitor insight, business management (e.g., marketing campaign management, alerts, customer surveys, coupons, discounts, etc.), point of sale data such as transaction history, failed transactions, reports, etc. In this way, one or more services are invoked to perform the intended action(s) 412, and a response it provided back to the user. In some embodiments, the response may provide intelligent suggestions based upon personalization and context of the user and business.

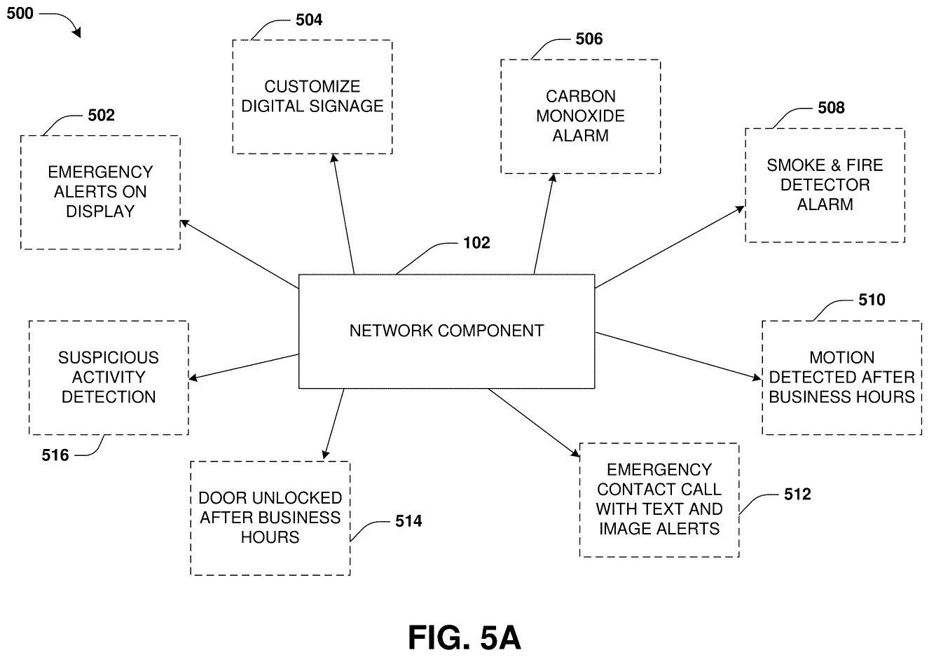

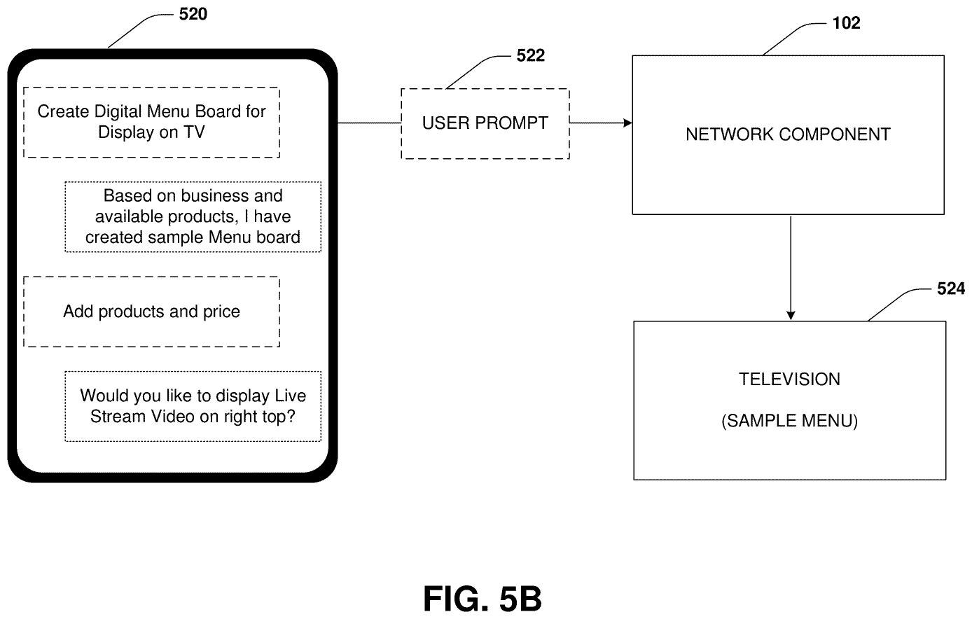

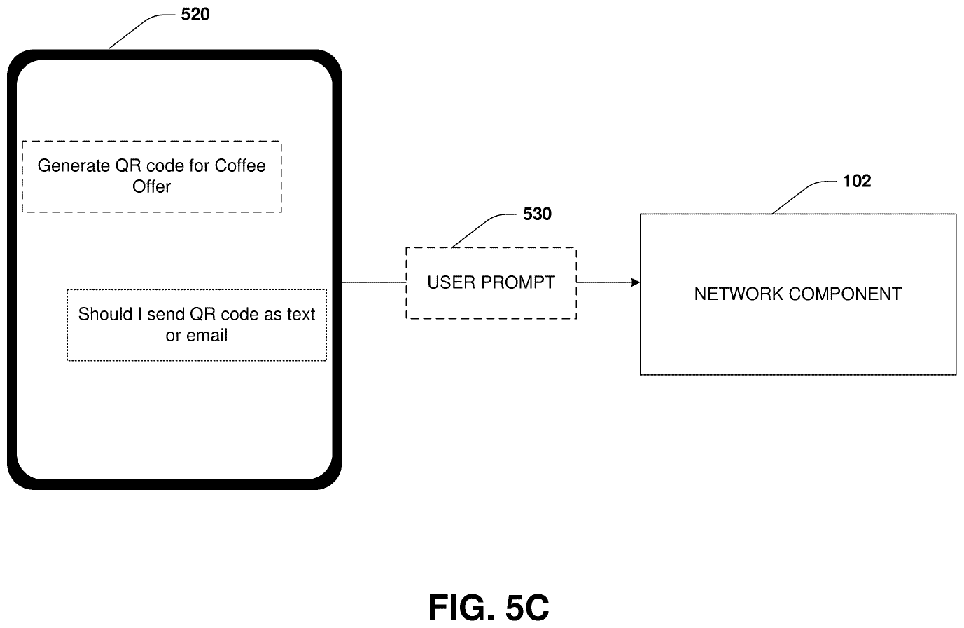

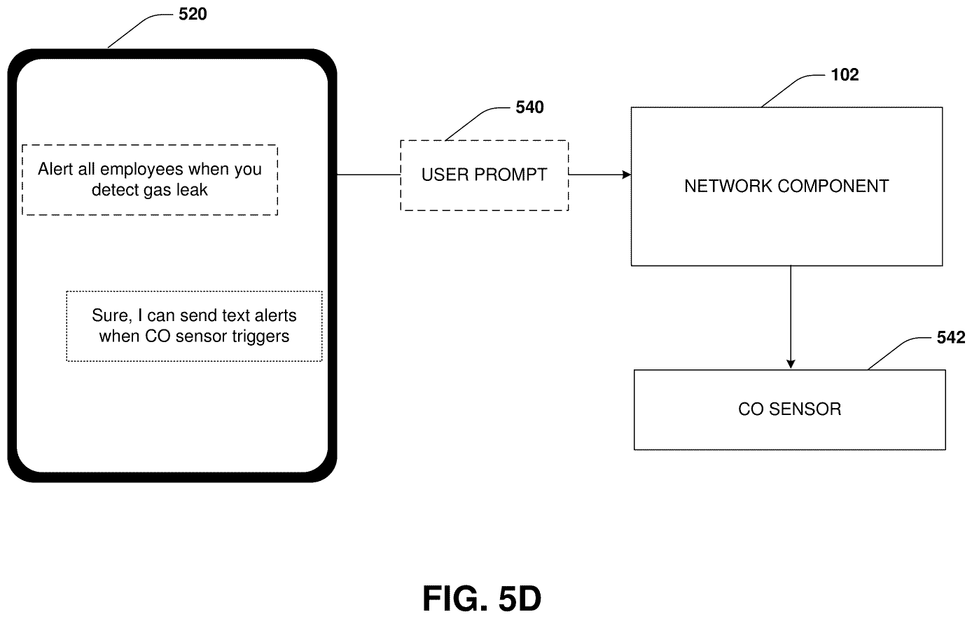

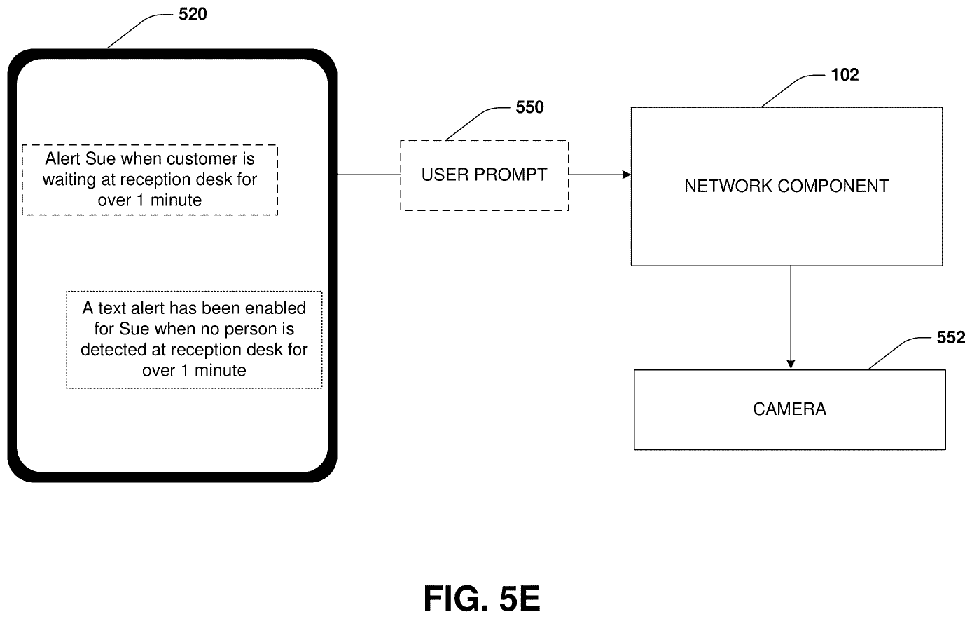

FIG. 5A-5E illustrate examples of a system for implementing an intent intelligence layer for a network component 102. The network component 102 may be connected to various devices that may be controlled or accessed as part of performing actions to satisfying an intent of a user prompt, as illustrated by system 500 of FIG. 5A. The intent intelligence layer may perform customize digital signage 504, such as to generate and display a digital display. The intent intelligence layer may perform carbon monoxide alarm alerts 506 and smoke and fire detector alarm alerts 508. The intent intelligence layer may perform motion detection 510, such as to monitor for motion in a store after business hours. The intent intelligence layer may perform a call or send a message 512 to a particular contact, such as an emergency contact call with text and image alerts if an event occurs. The intent intelligence layer may perform door lock detection 514, such as to detect and provide a notification of a door of the store being unlocked after business hours. The intent intelligence layer may perform suspicious activity detection 516, such as by using computer vision to evaluate imagery and/or video feeds from cameras at the store. The intent intelligence layer may display emergency alerts on a display. In this way, the intent intelligence layer of the network component 102 may perform various actions.

FIG. 5B illustrates a user device 520 connected to the network component 102. A user may input a user prompt 522 “create digital menu board for display on TV” that is received by intent intelligence layer of the network component 102. The intent intelligence layer may generate and display a sample menu on a television 524, and provide a response back to the user through the user device 520. The user may provide additional prompts and information that may result in additional actions, such as where the intent intelligence layer modifies the sample menu.

FIG. 5C illustrates the user inputting a user prompt 530 “generate QR code for Coffee Offer” into the user device 520, which is received by the intent intelligence layer of the network component 102. The intent intelligence layer may generate the QR code and ask the user how to send the QR code to the user, such as through text or email. In this way, the intent intelligence layer generates and provides the QR code to the user.

FIG. 5D illustrates the user inputting a user prompt 540 “Alert all employees when you detect gas leak” into the user device 520, which is received by the intent intelligence layer of the network component 102. The intent intelligence layer may start to monitor operation of a CO sensor 542, and indicates to the user that text alerts will be sent to all employees when the CO sensor 542 triggers.

FIG. 5E illustrates the user inputting a user prompt 550 “Alert Sue when customer is waiting at reception desk for over 1 minute” into the user device 502, which is received by the intent intelligence layer of the network component 102. The intent intelligence layer may start to monitor operation of a camera 552, and indicates to the user that text alerts will be sent to Sue when there is no person detected at the reception desk for over 1 minute.

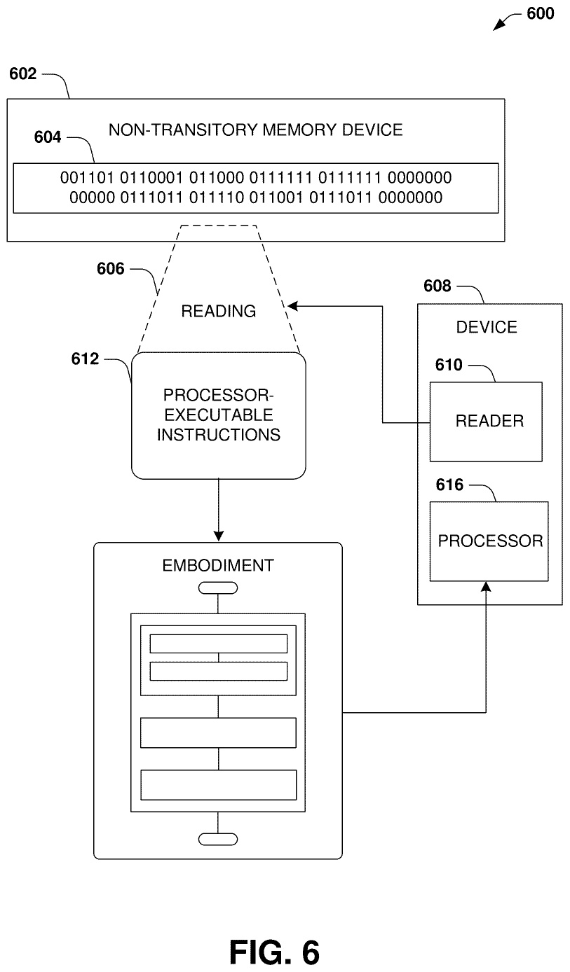

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1 and/or at least some of the example system 300 of FIG. 3, for example.

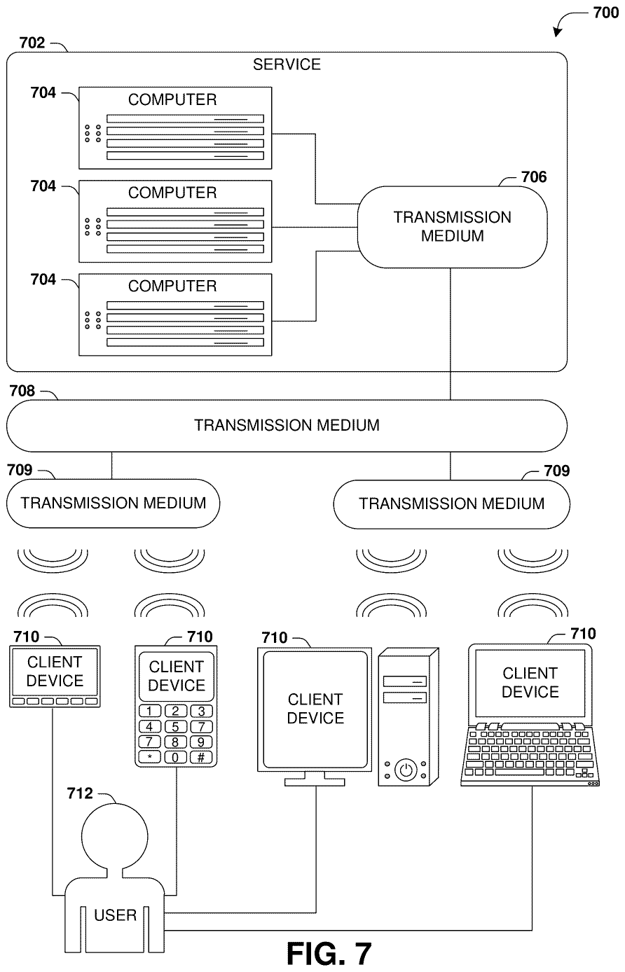

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

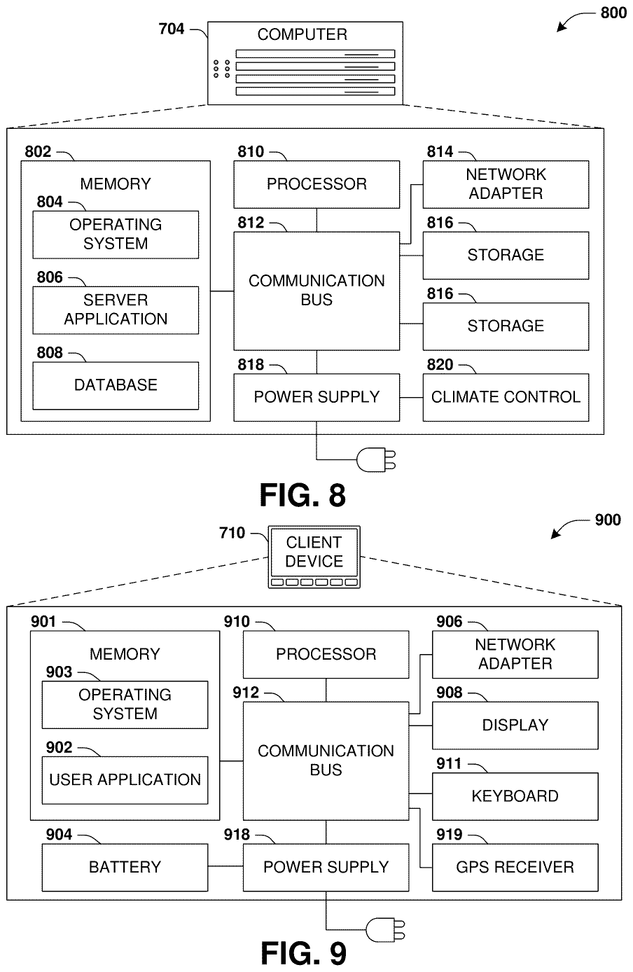

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
receiving, by a network component, a user prompt from a user;
generating, by an intent classifier, similarity scores between the user prompt and categories corresponding to services accessible to the network component;
determining an intent of the user prompt based upon contextual information of the user;
generating, by an artificial intelligence (AI) planner model, a task to perform based upon the intent and a category having a similarity score exceeding similarity scores of one or more other categories;
invoking an AI agent to perform the task, wherein the AI agent performs an application programming interface (API) call to a service, corresponding to the category, to retrieve a task result from the service;
generating a response to the user prompt based upon the task result; and
providing the response to the user.

2. The method of claim 1, wherein the network component is a router, and wherein the method further comprises:
extracting business information of a business associated with the user as the contextual information, wherein the user prompt relates to an aspect of the business.

3. The method of claim 2, wherein the AI planner model and the intent classifier are integrated into the router as an intent intelligence layer.

4. The method of claim 2, wherein the AI planner model and the intent classifier are hosted by a device connected to the router.

5. The method of claim 1, wherein the network component is a router connected to a device, and wherein the method further comprises:
invoking the service to control operation of the device; and
utilizing machine learning functionality to process data collected from the device to generate the task result.

6. The method of claim 1, further comprising:
dynamically generating the AI agent based upon the task; and
inputting service API details for the category into the AI agent for creating the API call.

7. The method of claim 1, further comprising:
generating, by the AI planner model, a plan to include a set of tasks to perform based upon the intent and one or more categories, wherein the set of tasks include the task;
for each task within the set of tasks, invoking a task specific AI agent assigned to perform a task of the set of tasks; and
generating the response based upon task results returned by task specific AI agents created for the set of tasks.

8. The method of claim 1, further comprising:
utilizing the service to monitor for an occurrence of an event; and
in response to the event occurring, generating an alert for the user.

9. The method of claim 1, further comprising:
generating, by the AI planner model, a plan to include a set of tasks to perform based upon the intent and one or more categories, wherein the set of tasks include the task;
evaluating the task result to determine whether the plan can continue to the next task or not; and
in response to determining that the plan cannot continue to the next task, generating a new plan with a new set of tasks.

10. The method of claim 9, further comprising:
in response to generating a threshold number of new plans, returning at least one of an error to the user or a request for clarification from the user.

11. A system, comprising:
one or more processors configured for executing instructions to perform operations comprising:
receiving, by a network component, a user prompt from a user;
generating, by an intent classifier, similarity scores between the user prompt and categories corresponding to services accessible to the network component;
determining an intent of the user prompt based upon contextual information of the user;
generating, by an artificial intelligence (AI) planner model, a task to perform based upon the intent and a category having a similarity score exceeding similarity scores of one or more other categories;
invoking an AI agent to perform the task, wherein the AI agent performs an application programming interface (API) call to a service, corresponding to the category, to retrieve a task result from the service;
generating a response to the user prompt based upon the task result; and
providing the response to the user.

12. The system of claim 11, wherein the operations further comprise:
generating a prompt vector to represent the user prompt;
generating category vectors to represent the categories; and
comparing the prompt vector to the category vectors to generate the similarity scores.

13. The system of claim 11, wherein the operations further comprise:
executing an action as the response, wherein the action includes at least one of live speech translation, video surveillance, automated scheduler manager functionality, business insight generation, business suggestion generation, periodic business analytic analysis, network diagnostic functionality, device onboarding, or a voice enabled operation.

14. The system of claim 11, wherein the operations further comprise:
invoking the service to automate execution of an action; and
populating the response with a result of executing the action.

15. The system of claim 11, wherein the operations further comprise:
receiving, over a network from a service provider, an update for dynamically updating service API details used by the AI agent to generate the API call to the service, wherein the update is applied to modify or replace a file used by the network component to store the service API details.

16. The system of claim 11, wherein the operations further comprise:
defining the category for a messaging service used to transmit messages to user equipment.

17. The system of claim 11, wherein the operations further comprise:
defining the category for an event monitoring service used to monitor at least one of a data source, a sensor, or a device for occurrence of events.

18. A non-transitory computer-readable medium storing instructions that when executed by one or more processors facilitate performance of operations comprising:
receiving, by a network component, a user prompt from a user;
generating, by an intent classifier, similarity scores between the user prompt and categories corresponding to services accessible to the network component;
determining an intent of the user prompt based upon contextual information of the user;
generating, by an artificial intelligence (AI) planner model, a task to perform based upon the intent and a category having a similarity score exceeding similarity scores of one or more other categories;
invoking an AI agent to perform the task, wherein the AI agent performs an application programming interface (API) call to a service, corresponding to the category, to retrieve a task result from the service;
generating a response to the user prompt based upon the task result; and
providing the response to the user.

19. The non-transitory computer-readable medium of claim 18, wherein the operations further comprise:
defining the category for a fixed wireless access service used to execute router tasks for the network component.

20. The non-transitory computer-readable medium of claim 18, wherein the operations further comprise:
defining the category for a computer vision service used to execute computer vision functionality upon imagery or video.
